(19) United States
(12) Patent Application Publication
(10) Pub. No.: US 2025/0389603 A1
(43) Pub. Date: Dec. 25, 2025

(54) PRESSURE TRANSMITTER OSCILLATOR MONITOR

(71) Applicant: Rosemount Inc., Shakopee, MN (US)

(72) Inventors: Brian E. Sofen, Minneapolis, MN (US); Nicholas Haywood, Brooklyn Park, MN (US)

(21) Appl. No.: 18/751,919

(22) Filed: Jun. 24, 2024

(51) Int. Cl. G01L 9/12; G01L 9/00

(52) U.S. Cl. CPC G01L 9/12; G01L 9/0072

(57) ABSTRACT

A pressure transmitter includes a pressure sensor having a variable capacitance that is indicative of a sensed pressure, a measurement circuit, an output circuit and an oscillator monitor circuit. The measurement circuit includes an oscillator configured to generate an alternating current (AC) drive signal that is applied to the pressure sensor, and a demodulator configured to demodulate a capacitance signal, which is generated by the pressure sensor in response to the AC drive signal, and produce a pressure signal that is indicative of the capacitance and the sensed pressure. The output circuit is configured to control a loop current in a current control loop to be within an operating range to indicate the sensed pressure based on the pressure signal. The oscillator monitor circuit is configured to monitor the AC drive signal and drive the loop current outside the operating range in response to an invalid AC drive signal.

### FIELD

Embodiments of the present disclosure relate to industrial process variable transmitters and, more specifically, to a pressure transmitter having an oscillator monitor circuit that operates to interrupt normal operation in the event of an oscillator malfunction.

### BACKGROUND

Process variable transmitters are used in industrial processes to sense process variables. Examples of process variables include temperature, flow rate, pressure, etc. The process variable transmitter senses a process variable and transmits information related to the process variable to a centralized location. The sensed process variable can be used to monitor an operation of the process and, in some instances, can be used to control an operation of the process.

For some applications, such as nuclear power plants, process variable transmitters are unable to utilize digital circuitry, which may be damaged by a harsh radiation environment. As a result, such process variable transmitters are required to utilize analog circuitry, and frequently utilize a two-wire process control loop to communicate process variable information to the centralized location. For example, a 4-20 mA process control loop may use a 4 mA current level to represent a low value of a process variable and a 20 mA current level to represent a high value. The same two-wire process control loop can also be used to power the process variable transmitter.

Some process variable transmitters, such as the Rosemount 3150 Series transmitter, utilize one or more pressure sensors having a capacitance that varies in response to an applied pressure. The capacitance of each pressure sensor is generally measured using an AC signal that is generated by an oscillator of the transmitter electronics. The measured signal may then be converted, for example, to a current level (e.g., 4-20 mA) over the two-wire process control loop.

On rare occasions, the oscillator of the transmitter electronics may fail to produce the AC signal and cause the transmitter to output the wrong pressure value (e.g., 4-20 mA).

### SUMMARY

Embodiments of the present disclosure are directed to pressure transmitters for an industrial process and methods of operating the pressure transmitters. One example of the pressure transmitter includes a pressure sensor having a variable capacitance that is indicative of a sensed pressure, a measurement circuit, an output circuit and an oscillator monitor circuit. The measurement circuit includes an oscillator configured to generate an alternating current (AC) drive signal that is applied to the pressure sensor, and a demodulator configured to demodulate a capacitance signal, which is generated by the pressure sensor in response to the AC drive signal, and produce a pressure signal that is indicative of the capacitance and the sensed pressure. The output circuit is configured to control a loop current in a current control loop to be within an operating range to indicate the sensed pressure based on the pressure signal. The safety circuit is configured to monitor the AC drive signal and drive the loop current outside the operating range in response to an invalid AC drive signal.

Another example of the pressure transmitter includes a pressure sensor having a variable capacitance that is indicative of a sensed pressure, a measurement circuit, an output circuit and a safety circuit. The measurement circuit includes an oscillator configured to generate an AC drive signal that is applied to the pressure sensor, and a demodulator configured to demodulate a capacitance signal, which is generated by the pressure sensor in response to the AC drive signal, and produce a pressure signal that is indicative of the capacitance and the sensed pressure. The output circuit is configured to control a loop current in a current control loop within an operating range to indicate the sensed pressure based on the pressure signal. The safety circuit includes an oscillator detect circuit and an override circuit. The oscillator detect circuit includes an optocoupler configured to output a mirrored AC drive signal corresponding to the AC drive signal, and a bridge rectifier configured to rectify the mirrored AC drive signal to produce an AC detect signal. The AC detect signal having a first state when the AC drive signal is valid and a second state when the AC drive signal is invalid. The override circuit is configured to override the current control circuit and drive the loop current outside the operating range in response to the second state of the AC detect signal.

In one example of a method of operating a pressure transmitter for an industrial process, a pressure is sensed by a pressure sensor. An AC drive signal is applied to the pressure sensor using an oscillator, and a capacitance signal is generated in response to the AC drive signal that is indicative of the sensed pressure. The capacitance signal is demodulated to produce a corresponding pressure signal. The AC drive signal is monitored by the safety circuit to detect whether the AC drive signal is valid or invalid. A loop current in a current control loop is controlled to be within an operating range to indicate the applied pressure based on the pressure signal when the AC drive signal is valid. The loop current is driven outside the operating range when the AC drive signal is invalid using the safety circuit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a process measurement system, in accordance with the prior art.

FIG. 2 is a simplified diagram of a process measurement system including a pressure transmitter, in accordance with embodiments of the present disclosure.

FIG. 3 is a simplified diagram of example circuitry of a pressure transmitter, in accordance with embodiments of the present disclosure.

FIG. 4 is a simplified circuit diagram illustrating an example of a safety circuit, in accordance with embodiments of the present disclosure.

FIG. 5 is a flowchart illustrating a method of operating a pressure transmitter, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

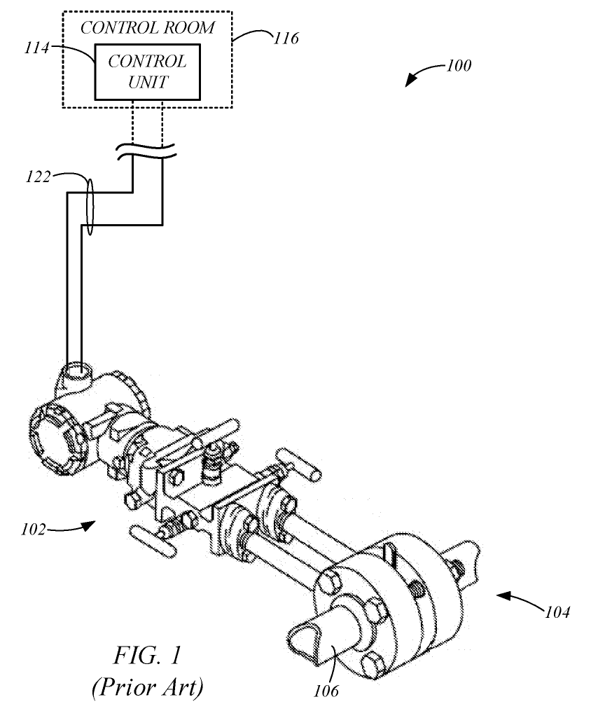

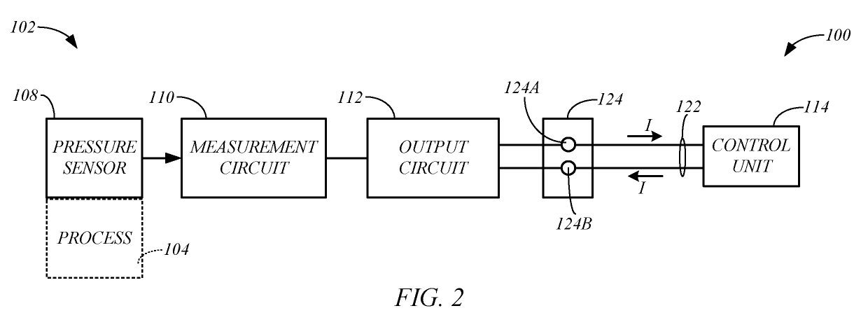

FIG. 1 is a simplified diagram of a process measurement system 100, in accordance with the prior art. FIG. 2 is a simplified diagram of a process measurement system 100 including an example pressure transmitter 102, in accordance with embodiments of the present disclosure.

The pressure transmitter 102 is generally configured to measure a pressure relating to an industrial process 104, such as a differential pressure, an absolute pressure, a gauge pressure, etc., for example. The process 104 may involve a fluid, which is transported through a pipe 106 as shown in FIG. 1, and/or contained in a tank, for example. The system 100 may perform processes that transform the material from a less valuable state into more valuable and useful products, such as petroleum, chemicals, paper, food, etc. For example, an oil refinery performs industrial processes that can process crude oil into gasoline, fuel oil, and other petrochemicals.

The pressure transmitter 102 includes a pressure sensor 108 that is configured to sense a pressure (e.g., differential, absolute, gauge, etc.) relating to the process 104, a measurement circuit 110, and an output circuit 112 that is configured to communicate a value of the sensed pressure to a computerized control unit 114. The control unit 114 may be remotely located from the pressure transmitter 102, such as in a control room 116 of the system 100, as shown in FIG. 1.

The measurement circuit 110 generally operates to process a signal 118 from the pressure sensor 108 that is indicative of the sensed pressure and output a signal 120 corresponding to the sensed pressure to the output circuit 112. The output circuit 112 generally operates to communicate a value corresponding to the signal 120 to the control unit 114 or to another receiving device.

The output circuit 112 may be coupled to the control unit 114 over a process control loop 122 that is connected to the pressure transmitter 102 at a terminal block 124, which may include a positive terminal 124A and a negative terminal 124B. The process control loop 122 may take the form of a two-wire, 4-20 milliamp (mA) process control loop, which may power the pressure transmitter 102, or another suitable control loop.

Communications between the pressure transmitter 102 and the control unit 114 may be performed using the output circuit 112 over the control loop 122 in accordance with conventional analog and/or digital communication protocols. For example, a value corresponding to the sensed pressure (e.g., signal 120) may be represented by an analog signal, such as a level of a loop current I (FIG. 2) flowing through the process control loop 122.

Digital communication protocols, such as the HART® communication standard, generally modulate digital signals onto the analog current level of the 2-wire process control loop 122. Other examples of digital communication protocols that may be used include Modbus, PROFIBUS, Foundation^{TM} Fieldbus, IO-Link, and other communication protocols.

In some embodiments, the pressure transmitter 102 may utilize only analog circuitry in order to meet certain safety requirements and/or to operate in certain harsh environments, such as nuclear power plants. Accordingly, such an embodiment of the pressure transmitter 102 is generally only configured to communicate with the control unit 114 using analog communication protocols, such as through the control of the loop current I, for example.

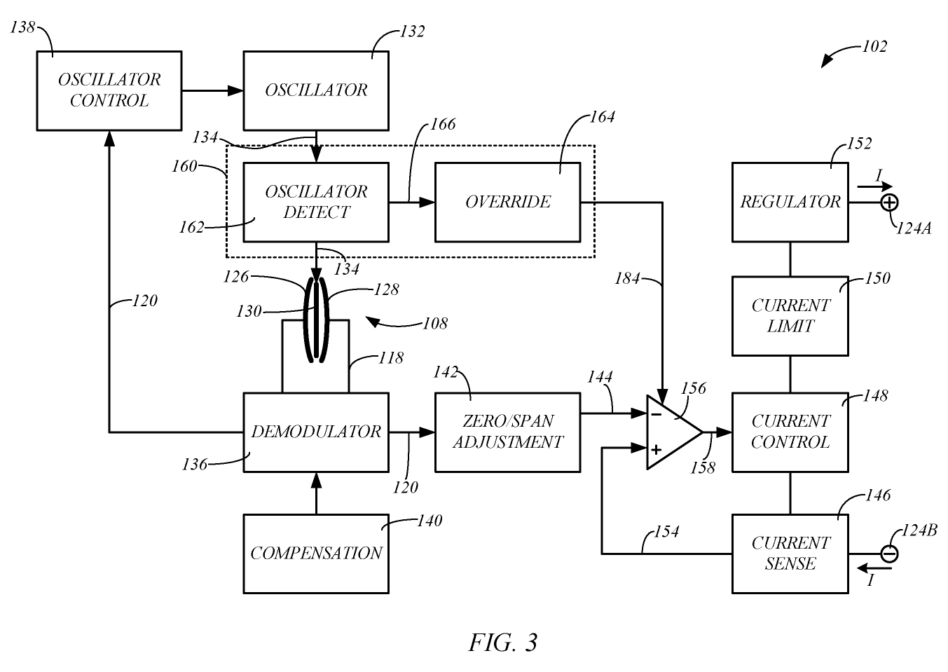

FIG. 3 is a simplified diagram of example circuitry of the pressure transmitter 102, in accordance with embodiments of the present disclosure. The pressure sensor 108 may take on a conventional form, such as a capacitive based pressure sensor, in which a capacitance of the sensor 108 varies based on the sensed pressure. For example, the pressure sensor 108 may comprise a pair of capacitive plates or electrodes 126 and 128 (hereinafter “plates”) that are separated by a diaphragm 130 having a position that shifts toward and away from the plates 126 and 128 in response to a differential pressure, thereby changing a capacitance between the plates 126 and 128.

The measurement circuit 110 represents circuitry that interacts with the pressure sensor 108 to obtain the sensed pressure. In one example, the measurement circuitry 110 is configured to measure the capacitance of the plates 126 and 128 relating to the sensed pressure using a suitable technique, such as by using a sigma/delta converter.

In one example, the measurement circuit 110 includes a conventional oscillator 132 that generates an alternating current (AC) drive signal 134 that is delivered to the diaphragm 130. A capacitance between the plates 126 and 128 that is generated in response to the AC drive signal 134 operates as a sensor or capacitance signal 118 that is indicative of the sensed pressure.

The measurement circuit 110 includes a conventional demodulator 136 that is configured to demodulate the capacitance signal 118 and produce a pressure signal 120 that is indicative of the sensed pressure. The pressure signal 120 may be provided to a conventional oscillator control circuit 138 of the measurement circuit 110 as feedback for controlling the AC drive signal 134 generated by the oscillator 132.

The measurement circuit 110 may also include one or more compensation circuits 140 to apply compensations to the pressure signal 120, in accordance with conventional techniques. For example, the compensation circuits 140 may compensate the pressure signal 120 based upon a temperature and non-linearities in the sensor measurements.

The output circuit 112 may include a conventional zero/span adjustment circuit 142 that converts the pressure signal 120 (e.g., 0-100 microamp current) into a voltage level signal 144. For example, the voltage level signal 144 may vary between 1 and 5 volts.

The output circuit 112 may include additional conventional circuits, such as a current sense circuit 146, a current control circuit 148, a current limit circuit 150 and/or a regulator circuit 152, that are used to control the loop current I. The current sense circuit 146 measures the loop current I and outputs a loop current signal 154, which is compared to the voltage level signal 144 using a comparator 156. The output 158 from the comparator 156 is supplied to the current control circuit 148, which regulates the amplitude of the loop current I to indicate the sensed pressure. The current limit circuit 150 operates to prevent the loop current I from exceeding a maximum amplitude (e.g., 20 mA), and the regulator circuit 152 operates to maintain a desired voltage across the terminals 124A and 124B.

It is understood that electronics components may occasionally fail. A malfunction of the oscillator 132 may terminate the production of the AC drive signal 134. The loss of the AC drive signal 134 may cause the pressure transmitter 102 to fail “on-scale,” meaning that the pressure transmitter 102 will output a loop current I value that is unrelated to the sensed pressure, but still within the operating range of the pressure transmitter 102 (e.g., 4-20 mA). In such a case, the pressure transmitter 102 falsely indicates a valid sensed pressure value without a notification that the indicated pressure value should be disregarded.

Embodiments of the present disclosure operate to address this potential latent oscillator malfunction issue using an oscillator monitor circuit 160 that monitors the AC drive signal 134 and drives the loop current I outside the operating range (e.g., 4-20 mA) of the pressure transmitter 102 in response to an invalid AC drive signal 134, such as a loss of signal condition. For example, the oscillator monitor circuit 160 may drive the loop current I below the minimum current level of the operating range, such as below 4 mA (e.g., 3 mA) in a 4-20 mA process loop. The resulting invalid loop current I may operate as a notification of the malfunction to the control unit 114, and/or a trigger for an alarm. The pressure transmitter 102 may then be taken offline and serviced to remedy the malfunction and avoid a potentially severe consequence.

In one example, the oscillator monitor circuit 160 includes an oscillator detect circuit 162 and an override circuit 164. The oscillator detect circuit 162 generally outputs an AC detect signal 166 based on the AC drive signal 134, which is indicative of either a valid AC drive signal 134 and a properly operating oscillator 132, or an invalid AC drive signal 134 (e.g. loss of signal) and a malfunctioning oscillator 132. When the AC detect signal 166 indicates a valid AC drive signal 134, the override circuit 164 does not interrupt the operation of the output circuit 112, and the pressure transmitter 102 operates as normal. However, when the AC detect signal 166 indicates an invalid AC drive signal 134, the override circuit 164 interrupts the normal operation of the output circuit 112 and drives the loop current I outside the operating range, thus indicating the invalid AC drive signal 134 and a malfunctioning oscillator 132.

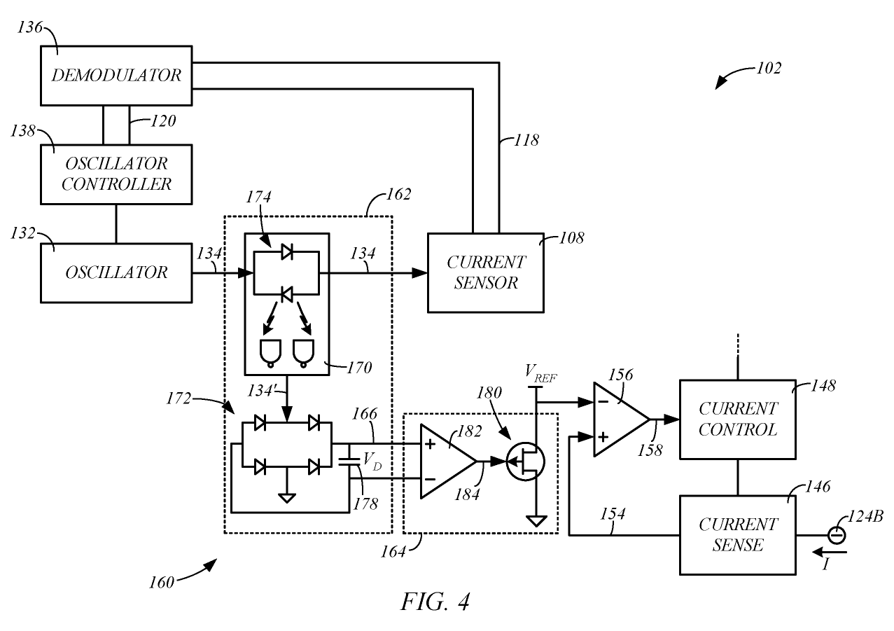

FIG. 4 is a simplified circuit diagram illustrating an example of the oscillator monitor circuit 160, in accordance with embodiments of the present disclosure. One example of the oscillator detect circuit 162 includes an optocoupler 170 and a bridge rectifier 172. The optocoupler 170 is connected to the AC drive signal 134 in a manner that does not affect the delivery of the AC drive signal 134 to the pressure sensor 108, such as through an anti-parallel diode pair 174. Thus, the optocoupler 170 outputs a corresponding mirror signal 134’ of the AC drive signal 134 to the bridge rectifier 172, which may take the form of a diode bridge as shown, or another suitable form.

When the oscillator 132 is functioning properly and outputs a valid AC drive signal 134 in the form of an AC voltage +/- V_{D} (e.g., 5V), the optocoupler 170 outputs a corresponding mirrored AC drive signal 134’ to the bridge rectifier 172, which operates to maintain the voltage V_{D}, which is proportional to the AC drive signal 134, across a capacitor 178. In one embodiment, the resultant positive voltage V_{D} across the capacitor 178 is output as a first state of the oscillator detect signal 166 to the override circuit 164.

In the event the oscillator 132 malfunctions and outputs an invalid AC drive signal 134 (e.g., no signal, about 0 V DC relative to a circuit common voltage), the optocoupler 170 provides the corresponding mirrored AC drive signal 134’ to the bridge rectifier 172. As a result, the voltage V_{D} across the capacitor drops to around 0 V DC relative to a circuit common voltage, and is output as a second state of the oscillator detect signal 166 to the override circuit 164.

Thus, the oscillator detects signal 166 output from the oscillator detect circuit 170 has a first state in the form of a positive DC voltage V_{D} in response to a valid AC drive signal 134, and a second state in the form of a low or 0 voltage V_{D} in response to an invalid AC drive signal 134 and a malfunctioning oscillator 132.

The override circuit 164 generally operates to interrupt the operation of the output circuit 112 in response to the second state of the oscillator detect signal 166, while avoiding interrupting the operation of the output circuit 112 in response to the first state of the oscillator detect signal 166. The override circuit 164 may take on any suitable form.

In one example, the override circuit 164 includes a switch 180, such as a p-channel junction field effect transistor (JFET), as shown in FIG. 4, or another suitable switch, that interrupts the operation of the output circuit 112 in response to the second state of the oscillator detect signal and allows the output circuit 112 to operate as normal in response to the first state of the oscillator detect signal. The override circuit 164 may include a comparator 182 that outputs a voltage 184 to control the switch 180 based on the oscillator detect signal 166 or voltage V_{D} across the capacitor.

Thus, in the illustrated example override circuit 164 having the p-channel JFET 180, the voltage V_{D} may be supplied to the non-inverting input of the comparator 182, and the output voltage 184 from the comparator 182 may be supplied to the gate of the JFET 180 to control whether the switch is “off” or non-conducting (e.g., first switch state), or “on” and conducting (e.g., second switch state). Accordingly, when the oscillator detect signal 166 is in the first state (positive high voltage V_{D}) in response to a valid AC drive signal, the output voltage 184 from the comparator 182 is a positive voltage that forward biases the gate-source junction and turns the JFET 180 off. As a result, a voltage V_{REF} corresponding to the pressure signal 120 or the output 144 from the zero/span adjustment circuit 142 is provided to the comparator 156 (see, e.g., FIG. 3) and the output circuit 112 operates as normal. Accordingly, the loop current I is controlled within the operating range of the transmitter 102 by the output circuit 112 to indicate the sensed pressure.

When the oscillator detect signal 166 is in the second state (0 or low voltage V_{D}), the output voltage 184 from the comparator is a negative or zero voltage, which reverse biases the gate-source junction and turns the JFET 180 on. This drops the voltage to the non-inverting input of the comparator 156 below the reference voltage V_{REF} and near the circuit common voltage. The resultant output 158 from the comparator 156 to the current control circuit 148 causes the loop current I to drop to an invalid value outside the operating range, such as below a minimum value (e.g., 4 mA) of its operating range. The invalid loop current I may be detected by the control unit 114, which may issue an alarm or another suitable notification of a detected malfunction in the pressure transmitter 102.

It is understood that the oscillator monitor circuit 160, such as the oscillator detect circuit 162 and/or the override circuit 164, may take on other similar forms while providing the desired interruption to the operation of the output circuit 112 in response to an invalid AC drive signal 134.

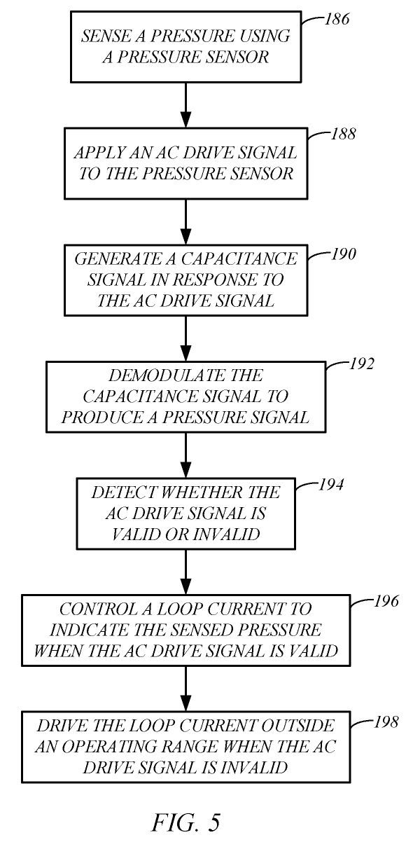

FIG. 5 is a flowchart illustrating a method of operating the pressure transmitter 102, in accordance with embodiments of the present disclosure. At 186, a pressure, such as a pressure corresponding to a process 104 (FIGS. 1 and 2), is sensed by a pressure sensor 108. At 188, an AC drive signal 134 is applied to the pressure sensor 108 using an oscillator 132, and a capacitance signal 118 is generated by the sensor 108 in response to the AC drive signal 134 that is indicative of the sensed pressure at 190. At 192, the capacitance signal 118 is demodulated, such as by the demodulator 136, to produce a corresponding pressure signal 120.

At 194, the AC drive signal 134 is monitored by an oscillator monitor circuit 160, which may be formed in accordance with the embodiments described above, to detect whether the AC drive signal 134 is valid or invalid. At 196, a loop current I in a current control loop 122 is controlled to be within an operating range of the pressure transmitter 102 to indicate the applied pressure based on the pressure signal 120 when the AC drive signal 134 is valid or, at 198, the loop current I is driven outside the operating range when the AC drive signal 134 is invalid.

In some embodiments, the method includes generating a notification or an alarm in response to the loop current I being outside the operating range using the control unit 114 or circuitry of the pressure transmitter 102, for example.

Although the embodiments of the present disclosure have been described with reference to preferred embodiments, workers skilled in the art will recognize that changes may be made in form and detail without departing from the spirit and scope of the present disclosure.

Specific details are given in the above-description to provide a thorough understanding of the embodiments. However, it is understood by those of ordinary skill in the art that the embodiments may be practiced without these specific details. For example, conventional circuits and other components may not be shown, or may be shown in block diagram form in order to avoid obscuring the embodiments in unnecessary detail.

What is claimed is:

1. A pressure transmitter for an industrial process comprising:
a pressure sensor having a variable capacitance that is indicative of a sensed pressure;
a measurement circuit including:
an oscillator configured to generate an alternating current (AC) drive signal that is applied to the pressure sensor; and
a demodulator configured to demodulate a capacitance signal, which is generated by the pressure sensor in response to the AC drive signal, and produce a corresponding pressure signal that is indicative of the capacitance and the sensed pressure;
an output circuit configured to control a loop current in a current control loop to be within an operating range to indicate the sensed pressure based on the pressure signal; and
an oscillator monitor circuit configured to monitor the AC drive signal and drive the loop current outside the operating range in response to an invalid AC drive signal.

2. The process variable transmitter according to claim 1, wherein the oscillator monitor circuit comprises:
an oscillator detect circuit configured to output an AC detect signal having a first state in response to a valid AC drive signal and second state in response to an invalid AC drive signal; and
an override circuit configured to drive the loop current outside the operating range in response to the second state of the AC detect signal.

3. The process variable transmitter according to claim 2, wherein the override circuit forces the loop current below a minimum current of the operating range in response to the second signal.

4. The process variable transmitter according to claim 3, wherein:
the operating range of the loop current is 4-20mA; and
the override circuit forces the loop current to less than 4mA in response to the second signal.

5. The process variable transmitter according to claim 4, wherein the transmitter is powered by the loop current.

6. The process variable transmitter according to claim 2, wherein:
the override circuit comprises a switch that is set to a first state in response to the first state of the AC detect signal and to a second state in response to the second state of the AC detect signal;
the loop current is controlled by the output circuit when the switch is in the first state; and
the loop current is driven outside the operating range when the switch is in the second state.

7. The process variable transmitter according to claim 6, wherein the first state of the AC detect signal comprises a first DC voltage and the second state of the AC detect signal comprises a second DC voltage that is less than the first DC voltage.

8. The process variable transmitter according to claim 7, wherein the oscillator detect circuit comprises:
an optocoupler configured to output a mirrored AC drive signal corresponding to the AC drive signal; and
a bridge rectifier configured to rectify the mirrored AC drive signal to produce the first state of the AC detect signal when the AC drive signal is valid and the second state of the AC detect signal when the AC drive signal is invalid.

9. A pressure transmitter for an industrial process comprising:
a pressure sensor having a variable capacitance that is indicative of a sensed pressure;
a measurement circuit including:
an oscillator configured to generate an alternating current (AC) drive signal that is applied to the pressure sensor; and
a demodulator configured to demodulate a capacitance signal, which is generated by the pressure sensor in response to the AC drive signal, and produce a pressure signal that is indicative of the capacitance and the sensed pressure;
an output circuit configured to control a loop current in a current control loop within an operating range to indicate the sensed pressure based on the pressure signal; and
an oscillator monitor circuit comprising:
an oscillator detect circuit including:
an optocoupler configured to output a mirrored AC drive signal corresponding to the AC drive signal; and
a bridge rectifier configured to rectify the mirrored AC drive signal to produce an AC detect signal having a first state when the AC drive signal is valid and a second state when the AC drive signal is invalid; and
an override circuit configured to override the current control circuit and drive the loop current outside the operating range in response to the second state of the AC detect signal.

10. The process variable transmitter according to claim 9, wherein the override circuit forces the loop current below a minimum current of the operating range in response to the second state of the AC detect signal.

11. The process variable transmitter according to claim 10, wherein:
the override circuit comprises a switch that is set to a first state in response to the first state of the AC detect signal and to a second state in response to the second state of the AC detect signal;
the loop current is controlled by the output circuit when the switch is in the first state; and
the loop current is driven outside the operating range when the switch is in the second state.

12. The process variable transmitter according to claim 11, wherein the first state of the AC detect signal comprises a first DC voltage and the second state of the AC detect signal comprises a second DC voltage that is less than the first DC voltage.

13. The process variable transmitter according to claim 12, wherein:
the operating range of the loop current is 4-20. mA; and
the override circuit forces the loop current to less than 4 mA in response to the second state of the AC detect signal.

14. The process variable transmitter according to claim 13, wherein the transmitter is powered by the loop current.

15. A method of operating a pressure transmitter for an industrial process comprising:
sensing a pressure using a pressure sensor;
applying an alternating current (AC) drive signal to the pressure sensor using an oscillator;
generating a capacitance signal in response to the AC drive signal that is indicative of the sensed pressure;
demodulating the capacitance signal to produce a corresponding pressure signal;
detecting whether the AC drive signal is valid or invalid using an oscillator monitor circuit; and
controlling a loop current in a current control loop including:
controlling the loop current to be within an operating range and to indicate the sensed pressure based on the pressure signal when the AC drive signal is valid; and
driving the loop current outside the operating range when the AC drive signal is invalid using the oscillator monitor circuit.

16. The method according to claim 15, including:
monitoring the AC drive signal;
generating an AC detect signal using an oscillator detect circuit comprising;
generating a first state of the AC detect signal when the AC drive signal is valid; and
generating a second state of the AC detect signal when the AC drive signal is invalid;
setting a switch of an override circuit to a first state and controlling the loop current to be within the operating range in response to the first state of the AC detect signal; and
setting the switch to a second state and driving the loop current outside the operating range in response to the second state of the AC detect signal.

17. The method according to claim 16, wherein:
generating the AC detect signal comprises:
generating a mirrored AC drive signal based on the AC drive signal using an optocoupler; and
rectifying the mirrored AC drive signal using a bridge rectifier;
the rectified mirrored AC drive signal forms the first state of the AC detect signal when the AC drive signal is valid; and
the rectified mirrored AC drive signal forms the second state of the AC detect signal when the AC drive signal is invalid.

18. The method according to claim 17, wherein the first state of the AC detect signal comprises a first DC voltage and the second state of the AC detect signal comprises a second DC voltage that is less than the first DC voltage.

19. The method according to claim 15, wherein:
the operating range of the loop current is 4-20. mA; and
the override circuit forces the loop current to less than 4 mA in response to the second signal.

20. The method according to claim 19, including powering the transmitter using the loop current.
